(19) United States
(12) Patent Application Publication
(10) Pub. No.: US 2009/0199023 A1
(43) Pub. Date: Aug. 6, 2009

(54) Processor and Semiconductor Device Capable of Reducing Power Consumption

(75) Inventors: Jong-Suk Lee, Seoul (KR); Jin-Seo Lee, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 12/366,232

(22) Filed: Feb. 5, 2009

(30) Foreign Application Priority Data
Feb. 5, 2008 (KR) 10-2008-0011886

(51) Int. Cl. G06F 1/26

(52) U.S. Cl. 713/300

(57) ABSTRACT

A processor and a semiconductor device capable of reducing power consumption is provided. The processor includes one or more logic blocks each having a logic circuit corresponding to m bits for processing m bits of data and a logic circuit corresponding to n bits for processing n bits of data, n being an integer smaller than m. A power control unit controls the processor for operation as an m-bit processor by providing a power voltage to the logic circuit corresponding to m bits, or controls the processor for operation as an n-bit processor by providing the power voltage to the logic circuit corresponding to n bits.

### CROSS-REFERENCE TO RELATED APPLICATION

This application claims priority to and the benefit of Korean Patent Application No. 10-2008-0011886, filed on Feb. 5, 2008, in the Korean Intellectual Property Office, the entire content of which is incorporated herein in its entirety by reference.

### BACKGROUND

1. Field of the Invention

The present invention relates to a processor and a semiconductor device, and more particularly, to a processor and a semiconductor device capable of reducing power consumption.

2. Description of Related Art

A processor, i.e., a device that processes data, is an example of various semiconductor devices manufactured by using a semiconductor process, and combines elements performing various digital functions, such as a register, an arithmetic logic unit (ALU), and a decoder. In particular, a microprocessor implemented on an integrated circuit (IC) chip is used in various fields due to its low cost and small size.

FIG. 1 is a block diagram of a conventional microprocessor 10. The microprocessor 10 typically includes one or more logic blocks processing data, such as a register 11, an ALU 12, and a control logic 13.

The register 11 stores and accesses data at a high speed. The ALU 12 often includes an adder and performs operations such as arithmetic and logic operations. The control logic 13 analyzes instructions and generates control signals for controlling the other logic blocks in the microprocessor 10.

Currently, products such as mobile devices, home appliances, and information technology (IT) application products require high-performance microprocessors. However, high-performance microprocessors are not required to perform some functions, for example, a Moving Pictures Experts Group (MPEG) audio layer 3 (MP3) reproduction function. As such, a low-power operation is desirable to reduce power consumption. If a high-performance microprocessor is used to perform the low-power operation, large power consumption occurs.

Typically, a power gating method can be used to perform a low-power operation of semiconductor devices. Dynamic and static power consumption of a logic block that is not currently used can be prevented by interrupting a current flowing into the logic block.

However, in a conventional power gating method, current is blocked or provided to all logic blocks. Thus, such a power gating method is not appropriate to prevent unnecessary power consumption that can occur when the high-performance microprocessor performs the low-power operation. Also, although a digital signal processor (DSP) or another microprocessor which has low-power characteristics and a smaller bit width of data to be processed operates at a lower speed in comparison to the high-performance microprocessor and can be used to solve the power consumption problem, the cost of implementing such a system increases. Therefore, a need exists for a processor and semiconductor device capable of reducing power consumption. The present invention provides a solution to meet such need.

### SUMMARY

An exemplary embodiment of the present invention provides a processor and a semiconductor device capable of preventing unnecessary power consumption by using a modified power gating method.

According to an exemplary embodiment of the present invention, there is provided

a processor having at least one logic block, each logic block having a logic circuit corresponding to m bits that processes m bits of data. A power control unit controls the processor for operation as an m-bit processor by providing a power voltage to the logic circuit corresponding to m bits, or that controls the processor for operation as an n-bit processor by providing the power voltage to a logic circuit corresponding to n bits of the m bits. The power control unit may be arranged so as to correspond to each of the at least one logic block.

The power control unit may be arranged so as to correspond to each of the at least one logic block.

The power control unit may include a first switch unit for controlling the power voltage to be provided to the logic circuit corresponding to upper (m-n) bits of the logic block; and a second switch unit for controlling the power voltage to be provided to the logic circuit corresponding to lower n bits of the logic block.

The first switch unit may include a first MOS transistor which is switched in response to a first control signal, and the second switch unit may include a second MOS transistor which is switched in response to a second control signal.

The processor may include a first mode for a high-performance operation and a second mode for a low-power operation, according to an application, and the power control unit may control the processor for operation as an m-bit processor by turning on the first and second MOS transistors in the first mode, and control the processor for operation as the n-bit processor by turning on the second MOS transistor in the second mode.

The processor may further include a control signal generation unit receiving mode information of the processor and generating the first and second control signals in response to the mode information.

The processor may further include a switch unit for controlling a ground voltage to be connected to the logic circuit corresponding to m bits and for controlling the ground voltage to be provided to the logic circuit corresponding to n bits, according to an application.

The at least one logic block may include a first logic block for storing data and/or instructions; a second logic block for performing an arithmetic logic operation on the data; and a third logic block for decoding the instructions and generating control signals for controlling logic blocks in the processor.

The third logic block may include an m-bit logic block including the logic circuit corresponding to m bits and an n-bit logic block including the logic circuit corresponding to n bits, and the power control unit may selectively provide the power voltage to one of the m-bit logic block and the n-bit logic block, according to an application.

According to an exemplary embodiment of the present invention, there is provided an m-bit processor including a first logic block for storing data and/or instructions; a second logic block for performing an arithmetic logic operation on the data; and a third logic block for decoding the instructions and for generating control signals for controlling logic blocks in the processor, wherein at least one of the first through third logic blocks includes a plurality of n-bit logic blocks, n being an integer smaller than m, each processing n bits of data, and wherein a power voltage is controlled to be independently provided to the plurality of n-bit logic blocks.

According to an exemplary embodiment of the present invention, there is provided an m-bit processor including at least one logic block. A power control unit controls a power voltage to be provided to the one or more logic blocks, wherein the at least one logic block from among the one or more logic blocks includes a first logic circuit corresponding to (m-n) bits, n is an integer smaller than m), and receives the power voltage through a first power line. A second logic circuit corresponding to n bits receives the power voltage through a second power line which is separated from the first power line.

According to an exemplary embodiment of the present invention, there is provided a semiconductor device including at least one logic block, each logic block connected to data paths which are arranged in parallel, and including an m-bit logic circuit which includes a first logic circuit and a second logic circuit respectively connected to first and second power lines, for processing data corresponding to an m-bit width. A power control unit controls a power voltage to be independently provided to the first logic circuit and to the second logic circuit for controlling a bit width of data to be processed in the at least one logic block.

According to an exemplary embodiment of the present invention, a semiconductor system is provided. The semiconductor system includes a processor having at least one logic block, each logic block having a logic circuit corresponding to m bits that processes m bits of data. A power control unit controls the processor for operation as an m-bit processor by providing a power voltage to the logic circuit corresponding to m bits, or that controls the processor for operation as an n-bit processor by providing the power voltage to a logic circuit corresponding to n bits of the m bits. A system memory is coupled to the processor and stores various instructions to execute application programs. A random access memory is also coupled to the processor and temporarily stores data.

### BRIEF DESCRIPTION OF THE DRAWINGS

FIG. 1 is a block diagram of a general microprocessor.

FIG. 2 is a block diagram of a processor according to an exemplary embodiment of the present invention.

FIG. 3 is a block diagram of a power control unit illustrated in FIG. 2.

FIG. 4 is a block diagram for describing the general operation of a processor according to an exemplary embodiment of the present invention.

FIG. 5 is a block diagram of an instruction decoder and control logic block of a processor according to an exemplary embodiment of the present invention.

FIG. 6 is a block diagram of an m-bit logic block and a power control unit of a processor according to an exemplary embodiment of the present invention.

FIG. 7A is a block diagram of a semiconductor device according to an exemplary embodiment of the present invention.

FIG. 7B is a block diagram of a semiconductor system according to an exemplary embodiment of the present invention.

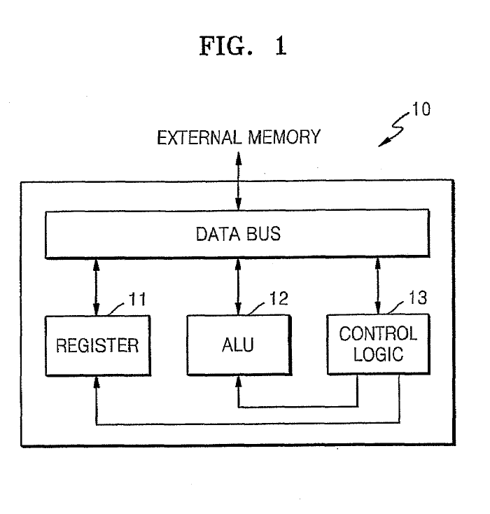

### DETAILED DESCRIPTION OF THE EMBODIMENTS

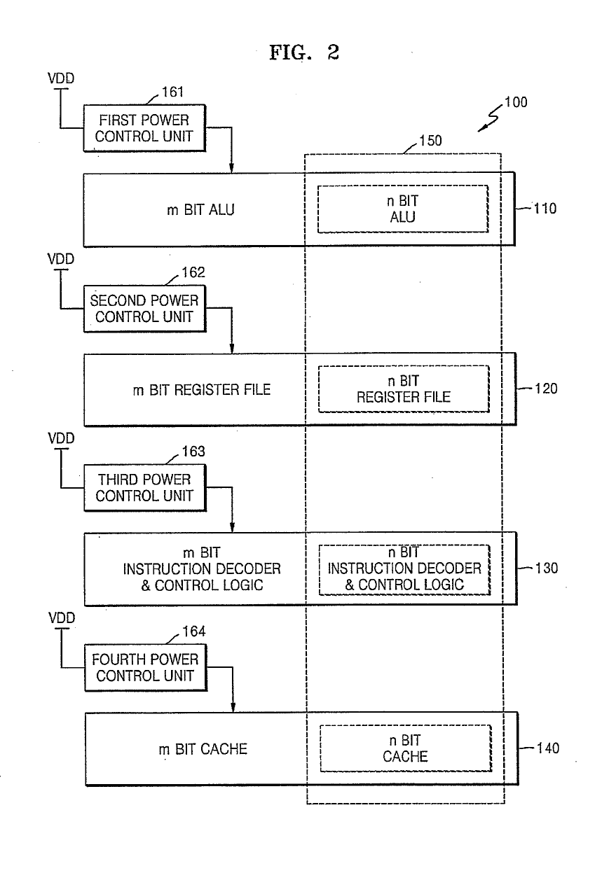

Referring now to FIG. 2, the processor 100 may include one or more logic blocks for performing various digital functions. The processor 100 executes an instruction in sequential operations. For example, the sequential operations may include fetching the instruction from memory, decoding the instruction, executing the instruction, and storing result data generated after the instruction is executed. However, those skilled in the art would appreciate that the processor 100 may have various configurations and thus some operations may be added to or omitted from the sequential operations.

As the logic blocks, the processor 100 may include ALU block 110 performing operations such as arithmetic and logic operations, a register file block 120 consisting of a group of registers for storing data or addresses, an instruction decoder and control logic block 130 analyzing instructions and generating control signals for controlling the other logic blocks in the processor 100, and a cache block 140 temporarily storing the instructions and the data.

However, those skilled in the art would appreciate that the processor 100 may have various structures according to data processing methods and the types of applications to be performed and may further include various different logic blocks.

In most cases, data paths or registers in the processor 100 may have a parallel structure according to the number of bits of data to be processed, and, if the processor 100 is an m-bit processor, instructions or data corresponding to m bits are transmitted and processed in parallel according to the parallel structure.

The processor 100 operates in a high-performance mode or a low-voltage mode according to the type of an application to be currently performed. Each of the ALU block 110, the register file block 120, the instruction decoder and control logic block 130, and the cache block 140 may have a parallel structure in which the data paths or the registers processing m-bit data are arranged in parallel. A logic circuit corresponding to m bits in each logic block is divided into a plurality of groups and a power gating method is independently performed with respect to each of the groups. As such, a power voltage VDD may be provided to the entire or a portion of the logic circuit of each logic block, and thus power consumption efficiency of the processor 100 may be improved.

For example, when a high-performance application is performed, the power voltage VDD is provided to the entire logic circuit of each logic block without performing the power gating method. On the other hand, when a low-performance low-power operation is performed, the power voltage VDD is not supplied to a portion of the logic circuit of each logic block by performing the power gating method. Thus, power consumption caused by the logic circuit corresponding to some bits, for example, upper bits of data or an instruction, may be prevented, and a width of the data or the instruction to be actually processed may be reduced, thereby reducing the power consumption.

Accordingly, the processor 100 may include a power control unit for controlling the power voltage VDD to be provided to at least one logic block. For example, the processor 100 may include a plurality of power control units separately corresponding to the logic blocks of the processor 100. In FIG. 2, first through fourth power control units 161, 162, 163, 164 are illustrated so as to respectively correspond to the ALU block 110, the register file block 120, the instruction decoder and control logic block 130, and the cache block 140. Each power control unit controls the power voltage VDD to be provided to a corresponding logic block.

In particular, when each power control unit controls the power voltage VDD to be provided to a logic circuit corresponding to m bits in a corresponding logic block, the power control unit controls the power voltage VDD to be provided to the entire logic circuit in the high-performance mode, and controls the power voltage VDD to be provided to a portion 150 of the logic circuit in the low-voltage mode. Thus, the processor 100 may operate as an n-bit processor (n is an integer smaller than m) in the low-voltage mode by providing the power voltage VDD to the logic circuit corresponding to n bits.

For example, the first power control unit 161 controlling the power voltage VDD to be provided to the ALU block 110 provides the power voltage VDD to the entire or a portion of the logic circuit corresponding to m bits in the ALU block 110 according to the high-performance mode or the low-voltage mode. In the low-voltage mode, the ALU block 110 receives data corresponding to n bits through some of data paths that are arranged in parallel so as to correspond to m bits, and performs an arithmetic logic operation on the data corresponding to n bits. For example, if the processor 100 has data processing performance of 32 bits, the processor 100 may operate as an 8-bit processor by selectively providing the power voltage VDD to the logic circuit corresponding to 8 bits in the low-voltage mode.

The same operation may be performed by the other logic blocks of the processor 100. In more detail, in the high-performance mode, the second power control unit 162 controlling the power voltage VDD to be provided to the register file block 120 provides the power voltage VDD to the entire logic circuit (for example, entire registers that are arranged in parallel) corresponding to m bits in the register file block 120. On the other hand, in the low-voltage mode, the second power control unit 162 provides the power voltage VDD to some registers in the register file block 120 (for example, registers corresponding to n bits), and inactivates the other registers, thereby preventing unnecessary power consumption.

Also, the third power control unit 163 for controlling the power voltage VDD to be provided to the instruction decoder and control logic block 130 may provide the power voltage VDD to the entire or a portion of the logic circuit in the instruction decoder and control logic block 130 according to the high-performance mode or the low-voltage mode. Due to characteristics of the instruction decoder and control logic block 130, in some cases, the instruction decoder and control logic block 130 may not have a parallel data processing structure or may not independently control the power voltage VDD with regard to a portion of the logic circuit. As such, unlike the ALU block 110 and the register file block 120, the instruction decoder and control logic block 130 may further include a logic circuit corresponding to n bits, in addition to the logic circuit corresponding to m bits, which will be described in more detail below.

Also, the fourth power control unit 164 for controlling the power voltage VDD to be provided to the cache block 140 provides the power voltage VDD to the entire or a portion of the logic circuit in the cache block 140. In more detail, in the high-performance mode, the entire cache block 140 is activated such that data or an instruction to be stored or read has a large width corresponding to m bits, and in the low-voltage mode, a portion of the cache block 140 is activated such that data or instruction to be stored or read has a small width corresponding to n bits.

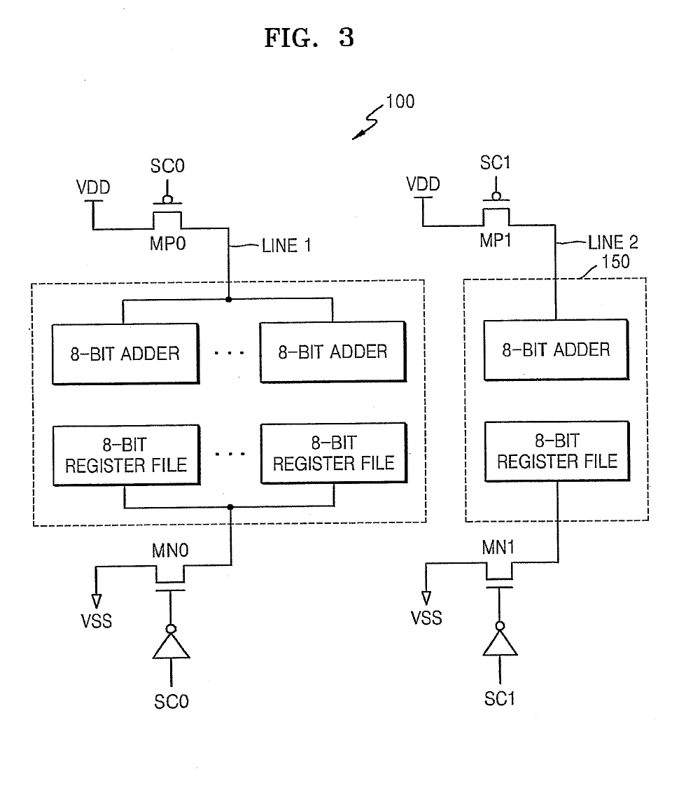

FIG. 3 is a block diagram for describing the detailed structure and operation of the first through fourth power control units 161, 162, 163, 164 illustrated in FIG. 2. FIG. 3 will be described in conjunction with FIG. 2.

In FIG. 3, each of the first through fourth power control units 161, 162, 163, 164 includes one or more MOS transistors and only some of microblocks in the processor 100 are illustrated for convenience of explanation. The processor 100 is a 32-bit processor and operates as an 8-bit processor in a low-power mode.

In the ALU block 110 having a plurality of adders, a power voltage VDD is separately provided to some adders and to other adders through different power lines. For example, from among the adders corresponding to 32 bits, the power voltage VDD is separately provided to adders corresponding to 24 upper bits through a first power line 1 and to adders corresponding to 8 lower bits through a second power line 2. Also, the first power control unit 161 for controlling the power voltage VDD to be provided to the ALU block 110 may include a first switch electrically connecting a power voltage source to the first power line and a second switch electrically connecting the power voltage source to the second power line. The first switch may include a first MOS transistor MP0 that is switched in response to a first control signal SC0 and the second switch may include a second MOS transistor MP1 that is switched in response to a second control signal SC1. Each of the first and second MOS transistors MP0, MP1 may be a p-type MOS (PMOS) transistor

The processor 100 may operate in a high-performance mode or a low-power mode according to the type of an application. In the high-performance mode, all of the first and second control signals SC0, SC1 have a low level and all of the first and second MOS transistors MP0, MP1 are turned on. Accordingly, the power voltage VDD is provided to the adders corresponding to 24 upper bits as the first power line is connected to the power voltage source and is also provided to the adders corresponding to 8 lower bits as the second power line is connected to the power voltage source. On the other hand, in the low-power mode, the first control signal SC0 has a high level and the second control signal SC1 has a low level such that the first MOS transistor MP0 is turned off and the second MOS transistor MP1 is turned on. Accordingly, the power voltage VDD is provided to only the adders corresponding to 8 lower bits since only the second power line is connected to the power voltage source.

The above-described structure may also be similarly applied to the other logic blocks in the processor 100. Although not shown, in the 32-bit register file block 120, a first power line providing the power voltage VDD a logic circuit corresponding to some bits (for example, 24 upper bits) of the register file block 120 may be separated from a second power line providing the power voltage VDD to another logic circuit corresponding to the other bits (for example, 8 lower bits) of the register file block 120. Also, the second power control unit 162 controlling the power voltage VDD to be provided to the register file block 120 may include a first switch controlling the power voltage VDD to be provided to the register file block 120 corresponding to 24 upper bits and a second switch controlling the power voltage VDD to be provided to the register file block 120 corresponding to 8 lower bits. The first and second switches of the second power control unit 162 may be respectively controlled by the first and second control signals SC0, SC1 as in the first power control unit 161.

The logic blocks in the processor 100 may be electrically connected to a predetermined ground voltage VSS. The processor 100 may further include switch units for controlling the ground voltage VSS to be connected to the logic blocks, for efficiently reducing power consumption. As an example, the register file block 120 will be representatively described in more detail. A first ground line providing the ground voltage VSS to the register file block 120 corresponding to 24 upper bits may be separated from a second ground line providing the ground voltage VSS to the register file block 120 corresponding to 8 lower bits. Also, a switch unit controlling the ground voltage VSS to be provided to the register file block 120 may include a first switch (for example, a first n-type MOS (NMOS) transistor MN0) controlling a ground voltage source to be electrically connected to the first ground line and a second switch (for example, a second NMOS transistor MN1) for controlling the ground voltage source to be electrically connected to the second ground line.

In each of the logic blocks of the processor 100, the first MOS transistor MP0 and the first NMOS transistor MN0 respectively controlling the power voltage VDD and the ground voltage VSS to be provided to a logic circuit corresponding to some upper bits (for example, 24 bits) are turned on or off at the same time. Accordingly, the first MOS transistor MP0 may be switched in response to the first control signal SC0 and the first NMOS transistor MN0 may be switched in response to an inversed signal of the first control signal SC0. Likewise, the second MOS transistor MP1 and the second NMOS transistor MN1 respectively controlling the power voltage VDD and the ground voltage VSS to be provided to the logic circuit corresponding to the other lower bits (for example, 8 bits) are turned on or off at the same time. For this, the second MOS transistor MP1 may be switched in response to the second control signal SC1 and the second NMOS transistor MN1 may be switched in response to an inversed signal of the second control signal SC1.

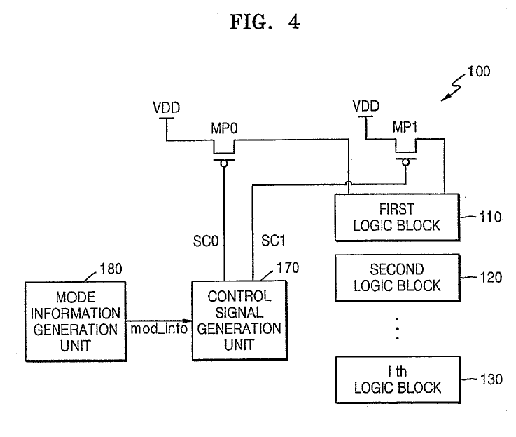

FIG. 4 is a block diagram for describing the general operation of a processor 100 according to an exemplary embodiment of the present invention. The processor 100 may include one or more logic blocks such as first through ith logic blocks 110, 120, . . . , 130, and may also include one or more MOS transistors such as first and second MOS transistors MP0, MP1 controlling a power voltage VDD to be provided to each logic block, as in a power control unit.

The processor 100 may further include a control signal generation unit 170 for generating one or more signals for control the first and second MOS transistors MP0, MP1 in the power control unit. If the processor 100 has two operational modes such as a high-performance mode operating as an m-bit processor (for example, a 32-bit processor) and a low-voltage mode operating as an n-bit processor (for example, an 8-bit processor), the control signal generation unit 170 may generate two control signals such as first and second control signals SC0, SC1.

The processor 100 may have more operational modes according to various types of required applications and the operational modes may have different bit widths of data or an instruction to be actually processed. As such, the control signal generation unit 170 may generate more control signals. For example, in a logic block including a logic circuit corresponding to 32 bits, power lines may be separately connected to logic circuits, each corresponding to 8 bits and each power line may be independently connected to a power voltage source. Thus, the processor 100 may have various operational modes.

The control signal generation unit 170 may receive operational mode information mod_info on the operational modes of the processor 100 from a mode information generation unit 180 for generating the control signals. The control signal generation unit 170 generates the first and second control signals SC0, SC1 in response to the operational mode information mod_info. If an application to be currently performed requires high performance, the control signal generation unit 170 generates the first and second control signals SC0, SC1 each having a low level so as to respectively provide the first and second control signals SC0, SC1 to the first and second MOS transistors MP0, MP1. If the application to be currently performed requires a low voltage, the control signal generation unit 170 generates the first control signal SC0 having a high level and the second control signal SC1 having a low level so as to respectively provide the first and second control signals SC0, SC1 to the first and second MOS transistors MP0, MP1.

The mode information generation unit 180 providing the operational mode information mod_info to the control signal generation unit 170 may be implemented in various ways. The mode information generation unit 180 may be included in the processor 100 so as to automatically set the operational modes of the processor 100. For example, the mode information generation unit 180 may determine a required operational mode by using an instruction executed in the processor 100, an address generated by decoding the instruction, or a degree of power consumption, and generate the operational mode information mod_info according to the determined operational mode so as to provide the operational mode information mod_info to the control signal generation unit 170. Also, the operational modes of the processor 100 may be directly set by a certain external instruction or signal provided from the outside of the processor 100. As such, the operational mode information mod_info to be provided to the control signal generation unit 170 may be the external instruction or signal.

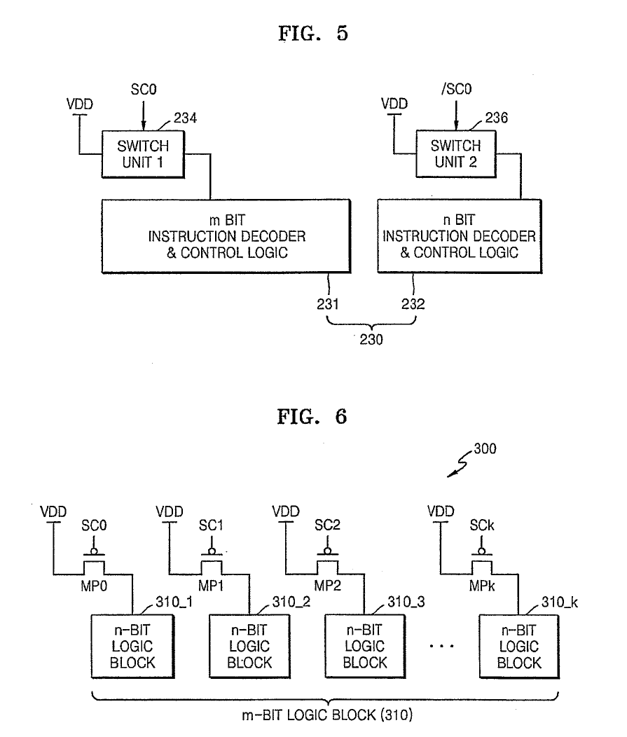

FIG. 5 is a block diagram of an instruction decoder and control logic block 230 of a processor according to an exemplary embodiment of the present invention. If the processor has a high-performance mode operating as an m-bit processor and a low-voltage mode operating as an n-bit processor, the instruction decoder and control logic block 230 in the processor 100 may include an m-bit instruction decoder and control logic block 231 and an n-bit instruction decoder and control logic block 232.

Since data paths or registers in the processor 100 are generally arranged in parallel according to data bits, logic circuits included in logic blocks of an m-bit processor may be divided into two or more groups and a power voltage VDD may be independently provided to the groups. However, if the instruction decoder and control logic block 230 in the processor 100 does not have a parallel data processing structure, or the power voltage VDD may not be independently provided to some logic circuits, the processor 100 may include both the m-bit instruction decoder and control logic block 231 used in the high-performance mode and the n-bit instruction decoder and control logic block 232 used in the low-voltage mode. The m-bit instruction decoder and control logic block 231 and the n-bit instruction decoder and control logic block 232 receives the power voltage VDD through different power lines and the power voltage VDD is provided one of the m-bit instruction decoder and control logic block 231 and the n-bit instruction decoder and control logic block 232 according to the operational mode of the processor. For this, first and second switch units 234, 236 respectively connected to the m-bit instruction decoder and control logic block 231 and the n-bit instruction decoder and control logic block 232 may be formed of the same type MOS transistors and may be respectively controlled by opposite level control signals SC0, /SC0.

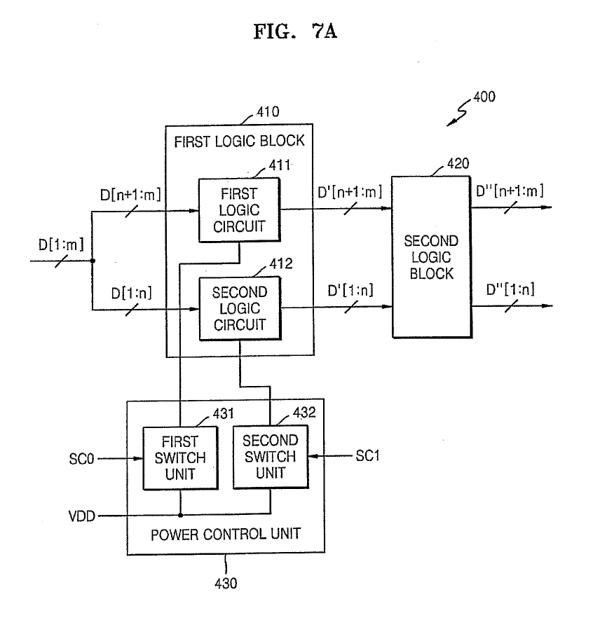

FIG. 6 is a block diagram of an m-bit logic block 310 and a power control unit of a processor 300 according to an exemplary embodiment of the present invention. The processor 300 may include one or more m-bit logic blocks 310 and each m-bit logic block 310 may include a plurality of n-bit logic blocks that are arranged in parallel.

As shown in FIG. 6, one m-bit logic block 310 may include first through kth n-bit logic blocks 310_1, 310_2, 310_3, . . . 310_{—}k and a power voltage VDD is provided to the first through kth n-bit logic blocks 310_1, 310_2, 310_3, . . . 310_{—}k through different power lines. For this, the power control unit corresponding to the m-bit logic block 310 may include switches separately connected to the first through kth n-bit logic blocks 310_1, 310_2, 310_3, . . . 310_{—}k.

For example, if the m-bit logic block 310 is formed of the first through fourth n-bit logic blocks 310_1 through 310_{—}k, the first n-bit logic block 310_1 of upper n bits receives the power voltage VDD through a first MOS transistor MP0 that is switched in response to a first control signal SC0. Likewise, the second n-bit logic block 310_2 of next n bits receives the power voltage VDD through a second MOS transistor MP1 that is switched in response to a second control signal SC1, and the third n-bit logic block 310_3 of next n bits receives the power voltage VDD through a third MOS transistor MP2 that is switched in response to a third control signal SC2. Also, the kth n-bit logic block 310_{—}k of lower n bits receives the power voltage VDD through a fourth MOS transistor MPk that is switched in response to a fourth control signal SCk.

The processor 300 having the above-described structure may have four operational modes. For example, in a first mode requiring the highest performance, all of the first through fourth MOS transistors MP0 through MP3 are turned on such that the processor 300 operates as a 32-bit processor. On the other hand, if an application requires a 24-bit operation, an operational mode of the processor 300 is set as a second mode such that the first MOS transistor MP0 corresponding to the first n-bit logic block 310_1 of upper n bits is turned off and the second through fourth MOS transistors MP1 through MP3 are turned on. Accordingly, the processor 300 operates as a 24-bit processor.

Likewise, if the application to be performed requires a 16-bit operation, the operational mode of the processor 300 is set as a third mode such that the first and second MOS transistors MP0, MP1 corresponding to the first and second n-bit logic blocks 310_1 and 310_2 of upper 2n bits are turned off and the third and fourth MOS transistors MP2 and MP3 are turned on. Accordingly, the processor 300 operates as a 16-bit processor. On the other hand, in a fourth mode requiring the lowest power, the first through third MOS transistors MP0 through MP2 are turned off and only the fourth MOS transistor MP3 corresponding to the fourth n-bit logic block 310_4 of lower n bits is turned on. Accordingly, the processor 300 operates as an 8-bit processor.

Hereinabove, exemplary embodiments of a processor that appropriately operate in a high-performance mode and a low-voltage mode by using a power gating method has been described based on the operations of a microprocessor. However, the exemplary embodiments are not limited thereto. A general semiconductor device having a memory device may also include various logic blocks processing data. Also, when the data is processed, if paths of data or control signals or registers storing the data are arranged in parallel according to data bits, the power gating method may be appropriately used. Those skilled in the art would appreciate that the embodiments of the inventive concept may be applied to general semiconductor devices.

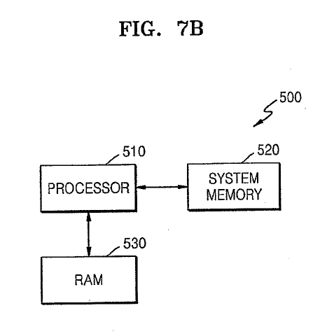

FIG. 7A is a block diagram of a semiconductor device 400 according to an exemplary embodiment of the present invention. m-bit data D[1:m] may be provided in parallel to the semiconductor device 400. The semiconductor device 400 may include at least one logic block, each logic block processing the m-bit data D[1:m]. For example, the semiconductor device 400 may include a first logic block 410 receiving the m-bit data D[1:m] in parallel, and a second logic block 420 receiving and processing data D′[1:m] output from the first logic block 410 and generating data D″[1:m].

At least one of the logic blocks included in the semiconductor device 400 may include an m-bit logic circuit that may include a plurality of logic circuits independently receiving a power voltage VDD through different power lines. For example, the m-bit logic circuit may include a first logic circuit processing upper m-n bits of the data D[1:m], and a second logic circuit 412 processing lower n bits of the data D[1:m].

The semiconductor device 400 may include a power control unit 430 independently controlling the power voltage VDD to be provided to the first and second logic circuits 411, 412. The power control unit 430 may include a first switch unit 431 switched in response to a first control signal SC0 and delivering the power voltage VDD to the first logic circuit 411, and a second switch unit 432 switched in response to a second control signal SC1 and delivering the power voltage VDD to the second logic circuit 412. As such, a bit width of data to be processed by the semiconductor device 400 may be controlled. For example, when the semiconductor device 400 operates in a high-performance mode to process a large amount of data, the bit width of data to be processed by the semiconductor device 400 is increased by providing the power voltage VDD to the first and second logic circuits 411, 412. On the other hand, when the semiconductor device 400 operates in a low-performance mode, the bit width of data to be processed by the semiconductor device 400 is reduced by providing the power voltage VDD to one of the first and second logic circuits 411, 412.

FIG. 7B is a block diagram of a semiconductor system 500 according to an exemplary embodiment of the present invention. The semiconductor system 500 may include a processor 510 operating either as an m-bit processor or an n-bit processor. The processor 510 is identical to the processor 100 illustrated in FIG. 2. In addition to the processor 510, the semiconductor system 500 may further include a system memory 520 storing various instructions required to execute application programs, and a random access memory (RAM) 530 temporarily storing data. The processor 510 includes a plurality of logic blocks and at least one of the logic blocks includes a logic circuit corresponding to m bits. A predetermined power control unit included in the semiconductor system 500 provides a power voltage to the logic circuit corresponding to the m bits, or the logic circuit corresponding to some of the m bits (e.g., n bits).

While exemplary embodiments of the present invention have been particularly shown and described, it will be understood that various changes in form and details may be made therein without departing from the spirit and scope of the following claims.

What is claimed is:

1. A processor comprising:
at least one logic block, each logic block comprising a logic circuit corresponding to m bits that processes m bits of data; and
a power control unit that controls the processor for operation as an m-bit processor by providing a power voltage to the logic circuit corresponding to m bits, or that controls the processor for operation as an n-bit processor by providing the power voltage to a logic circuit corresponding to n bits of the m bits.

2. The processor of claim 1, wherein the power control unit corresponds to each of the logic blocks.

3. The processor of claim 1, wherein the power control unit comprises:
a first switch unit that controls the power voltage to be provided to a logic circuit corresponding to upper m-n bits of the at least one logic block; and
a second switch unit that controls the power voltage to be provided to the logic circuit corresponding to n bits of m bits of the at least one logic block.

4. The processor of claim 3, wherein the first switch unit comprises a first MOS transistor switchable in response to a first control signal, and
wherein the second switch unit comprises a second MOS transistor switchable in response to a second control signal.

5. The processor of claim 4, further comprising a first mode for a high-performance operation and a second mode for a low-power operation, in accordance with an application,
wherein the power control unit controls the processor for operation as an m-bit processor by turning on the first MOS and the second MOS transistor in the first mode, and controls the processor for operation as the n-bit processor by turning on the second MOS transistor in the second mode.

6. The processor of claim 5, further comprising a control signal generation unit that receives mode information of the processor and generates the first control signal and the second control signal in response to the mode information.

7. The processor of claim 1, further comprising a switch unit that controls a ground voltage connectable to the logic circuit corresponding to m bits and that controls a ground voltage provideable to the logic circuit corresponding to n bits of the m bits, in accordance with an application.

8. The processor of claim 1, wherein the at least one logic block comprises:
a first logic block that stores data and/or instructions;
a second logic block that performs an arithmetic logic operation on the data; and
a third logic block that decodes the instructions and generates control signals that control logic blocks in the processor.

9. The processor of claim 8,
wherein the third logic block comprises an m-bit logic block comprising the logic circuit corresponding to m bits and an n-bit logic block comprising the logic circuit corresponding to n bits of the m bits; and
wherein the power control unit selectively provides the power voltage to one of the m-bit logic block and the n-bit logic block, in accordance with an application.

10. An m-bit processor comprising:
a first logic block that stores data and/or instructions;
a second logic block that performs an arithmetic logic operation on the data; and
a third logic block that decodes the instructions and generating control signals that control logic blocks in the processor,
wherein at least one of the first logic block, the second logic block and third logic block comprises a plurality of n-bit logic blocks, n being an integer smaller than m, each n-bit logic block processing n bits of data, and
wherein a power voltage is independently provided to the plurality of n-bit logic blocks.

11. The processor of claim 10, further comprising:
a power control unit that separately provides the power voltage to the plurality of n-bit logic blocks in response to at least one control signal; and
a control signal generation unit that generates the at least one control signal in accordance with an application.

12. The processor of claim 10, comprising a first mode for a high-performance operation and a second mode for a low-power operation, in accordance with an application,
wherein the power control unit controls the number of n-bit logic blocks receiving the power voltage in the first mode to be greater than the number of n-bit logic blocks receiving the power voltage in the second mode.

13. An m-bit processor comprising:
at least one logic block; and
a power control unit that controls a power voltage provideable to the at least logic blocks,
wherein the at least one logic block comprises:
a first logic circuit corresponding to m-n bits, n being an integer smaller than m, that receives the power voltage through a first power line; and
a second logic circuit corresponding to n bits that receives the power voltage through a second power line separated from the first power line.

14. The m-bit processor of claim 13, wherein the power control unit comprises:
a first switch unit connected to the first power line, the first switch unit providing the power voltage to the first power line in response to a first control signal; and
a second switch unit connected to the second power line, the second switch unit providing the power voltage to the second power line in response to a second control signal.

15. The m-bit processor of claim 14, further comprising a first mode for a high-performance operation and a second mode for a low-power operation, in accordance with an application,
wherein the power control unit controls the processor for operation as an m-bit processor by providing the power voltage to the first logic circuit and to the second logic circuit in the first mode, and controls the processor for operation as an n-bit processor by providing the power voltage to the second logic circuit in the second mode.

16. The processor of claim 14, further comprising a control signal generation unit that receives mode information of the processor and generates the first control signal and the second control signal in response to the mode information.

17. A semiconductor device comprising:
at least one logic block, each logic block connected to data paths in parallel and comprising an m-bit logic circuit which includes a first logic circuit and a second logic circuit respectively connected to a first power line and a second power line, the m-bit logic circuit processing data corresponding to an m-bit width; and
a power control unit that controls a power voltage to be independently provided to the first logic circuit and the second logic circuit, the power control unit controlling a bit width of data processable in the at least one logic block.

18. The semiconductor device of claim 17, wherein the power control unit comprises:
a first switch unit connected between a power voltage source and the first power line, the first switch unit providing the power voltage to the first power line in response to a first control signal; and
a second switch unit connected between the power voltage source and the second power line, the second switch unit providing the power voltage to the second power line in response to a second control signal.

19. The semiconductor device of claim 18, comprising a first mode for a high-performance operation and a second mode for a low-power operation,
wherein the power control unit controls the power voltage provideable to the first logic circuit and to the second logic circuit by turning on the first switch unit and the second switch unit in the first mode, and controls the power voltage provideable to one of the first logic circuit and the second logic circuit by turning on one of the first switch unit and second switch unit in the second mode.

20. The semiconductor device of claim 17, wherein the first logic circuit corresponds to upper m-n bits, n being an integer smaller than m, from among m bits of the m-bit logic circuit, and
wherein the second logic circuit corresponds to lower n bits from among m bits of the m-bit logic circuit.

21. A semiconductor device comprising a processor, the processor comprising:
at least one logic block, each logic block comprising a logic circuit corresponding to m bits that processes m bits of data; and
a power control unit that controls the processor for operation as an m-bit processor by providing a power voltage to the logic circuit corresponding to m bits, or that controls the processor for operation as an n-bit processor by providing the power voltage to a logic circuit corresponding to n bits of the m bits.

22. A semiconductor system comprising:
a processor comprising:
at least one logic block, each logic block comprising a logic circuit corresponding to m bits that processes m bits of data; and
a power control unit that controls the processor for operation as an m-bit processor by providing a power voltage to the logic circuit corresponding to m bits, or that controls the processor for operation as an n-bit processor by providing the power voltage to a logic circuit corresponding to n bits of the m bits;
a system memory, coupled to the processor, that stores various instructions to execute application programs; and
a random access memory, coupled to the processor, that temporarily stores data.
